(19) United States
(12) Patent Application Publication
(10) Pub. No.: US 2024/0112246 A1
(43) Pub. Date: Apr. 4, 2024

(54) SYSTEM FOR DYNAMIC FOOD ORDER FULFILLMENT WITH INTELLIGENT VIRTUAL ASSISTANT

(71) Applicant: WEB FOX TECHNOLOGY, LLC, St. Pete Beach, FL (US)

(72) Inventor: Vivien Cambridge, Myrtle Beach, SC (US)

(21) Appl. No.: 18/480,240

(22) Filed: Oct. 3, 2023

Related U.S. Application Data
(60) Provisional application No. 63/412,686, filed on Oct. 3, 2022.

(51) Int. Cl. G06Q 30/0601; G06Q 10/083

(52) U.S. Cl. CPC G06Q 30/0635; G06Q 10/083

(57) ABSTRACT

A system allows the dynamic, interactive placement and fulfillment of food delivery orders where a server in a first location receives an order for food from a customer connected device at a second location. The order is sent to the merchant device in a third location and upon confirmation from the merchant through the merchant device, the server device notifies the courier device in a fourth, mobile location. The courier device displays information related to the order in a graphical user interface for courier interaction. The courier device communicates with an intelligent virtual assistant implemented in software in the courier device. The intelligent virtual assistant analyzes data related to the order, communicates details verbally to the courier, accepts and analyzes verbal utterances from the courier, and performs tasks based on the utterances. The system thereby allows safe operation of the vehicle driven by the courier during the food delivery process.

### CROSS REFERENCE TO RELATED APPLICATIONS

This application claims the benefit of U.S. Provisional Application No. 63/412,686 filed on Oct. 3, 2022, and entitled System for Dynamic Food Order Fulfillment with Intelligent Virtual Assistant, which is incorporated by reference as if fully set forth herein.

### TECHNICAL FIELD

The present disclosure is directed to a system for food order fulfillment, and more particularly it is directed to a system for dynamic food order fulfillment utilizing an intelligent virtual assistant.

### BACKGROUND OF THE INVENTION

The convenience afforded by food delivery services has resulted in exponential growth of this industry. Electronic placement of orders for food items was an early application of the internet. For example, in U.S. Pat. No. 4,797,818, Cotter discloses a computerized food order/delivery system wherein a central computer accepts customer food orders through a modem and, based on a customer identifier, automatically selects the store that is to prepare the food for delivery to the customer. With the advent of connected devices coupled with GPS navigation services, it is now possible to accept orders for specific items of prepared food and then deliver the food to a specific customer, who is miles away, within minutes. There is now substantial competition for online food delivery orders between delivery services.

Innovations to gain advantage in this market include U.S. Pat. No. 9,269,103 to Kumar et al., which discloses a method for electronically managing orders where orders may be combined as they are distributed to couriers for improved efficiency. Couriers in many of these systems are semi-autonomous operators who contract with the food delivery service to accept orders, pick up food items, and deliver them for a fee. Besides competition between service providers, there is also substantial competition for delivery orders between mobile couriers who deliver the food to customers. These couriers are generally driving when orders reach their connected devices. Details of the order are displayed on a Graphical User's Interface (GUI) (i.e., a mobile device screen) and the driver has a limited period of time to view the order on the GUI screen, analyze the information, decide if he or she wants to accept the order, and respond by manipulating the touch screen on the device. The audible notification of an order and subsequent engagement with the device is a sometimes dangerous distraction from the driving task. In addition, some tasks that the courier could perform if not busy driving may be neglected. For example, the courier could communicate information by text or call about the delivery to the food delivery service or the customer. Such communication can be crucial in managing customer satisfaction and efficiency.

Therefore, it is desirable to have a system that can aid food delivery drivers or couriers in efficiently and safely performing their delivery tasks.

### SUMMARY OF THE INVENTION

The present disclosure provides a mechanism and process relating to dynamically accepting orders for food items, notifying merchants of the orders, and delivering the orders to a virtual assistant which virtual assistant communicates in real time with a mobile courier who is driving a delivery vehicle.

In one aspect, an order processing server is provided suitable for receiving, through a website, orders for certain food items offered for sale by a merchant. The server receives payment for these orders and communicates with a digital device in the merchant's location to initiate preparation of the order. The server receives from the merchant an expected pick-up time for the order. The server then communicates with a virtual assistant component in the vehicle (or a courier) who is available to fulfill the order, and sends details related to the items ordered, the fee expected to the courier, the location of the merchant, and the location of the customer.

The virtual assistant subsequently announces the order and analyzes details pertaining to the order, relaying to the courier those details needed for accepting the order and details related to navigation. For example, the virtual assistant may be trained to examine routes to the merchant and to the customer, compute mileage and make of the vehicle (based on the fee and factors such as final location of the courier), and recommend related data to acceptance of the order. The virtual assistant also includes components for analyzing spoken words uttered or spoken by the courier, and the virtual assistant determines the intended request for information or commands. As such, when the virtual assistant receives a request for information, the virtual assistant retrieves the requested information from the data received from the server. If necessary, the virtual assistant may autonomously, or upon verbal command from the courier, communicate digitally with the server for additional information, text or call the food ordering service support line for additional data, text or call the merchant for additional data, or text or call the customer for additional data. The virtual assistant may also verify routes and addresses to reduce delivery time and problems. When necessary, the virtual assistant may send courtesy text messages to the merchant or the customer to keep them appraised of the status of the fulfillment.

In performing the tasks outlined above, the virtual assistant allows a user/driver/courier to maintain his/her eyes on the road and his/her hands on the steering wheel at all times. In turn, this ensures the courier's safety and keeps other drivers on the road safe as well, while at the same time the courier is more efficient and provides better customer service to the customers who have requested the food delivery service. Since it is important for the service to force compliance with laws and requirements, communication with the virtual assistant is exclusively audial, while visual communication from and touch input to the virtual assistance are suspended while the vehicle is moving.

According to one aspect, the present disclosure is directed to a system for processing orders for food through a network processor and transmitting the orders for food to a courier. The system can include a customer processor at a customer location configured to transmit a food order through the network processor. The system can also include aa delivery service processor at a delivery service location configured to receive the food order and transmit the food order to a merchant processor at a merchant location. The merchant processor can be configured to process the food order and transmit a signal to the delivery service processor accepting or declining the food order. Further, the system can include a virtual assistant device at a courier location, the virtual assistant device being communicatively coupled to a mobile device of the courier. The virtual assistant device can be configured to receive food order data, process the food order data, and produce recommendations based on the food order data, with the recommendations being at least audibly broadcast to the courier.

In one aspect, the virtual assistant device includes a speaker for audibly broadcasting information to the courier.

In one aspect, the audible broadcasting of information includes verbally broadcasting information to the courier while the courier drives a vehicle.

In one aspect, the virtual assistant device includes a microphone for receiving verbal inputs from the courier while the courier drives a vehicle.

In one aspect, the virtual assistant device is a separate physical device from the mobile device of the courier, and the virtual assistant device is positioned within proximity of the mobile device of the courier.

In one aspect, the virtual assistant device includes: a microphone configured to receive verbal inputs from the courier; a speaker configured to audibly broadcast information to the courier; a display configured to display graphics, the display includes a touch screen component configured for entering data and controlling the virtual assistant device; and a power source for providing electrical energy to the virtual assistant device.

In one aspect, the touch screen of the display is at least partially disabled when the courier and the virtual assistant device are in motion.

In one aspect, the virtual assistant device includes a wireless adapter for communicatively coupling the virtual assistant device to the mobile device of the courier through wireless technology.

In one aspect, the virtual assistant device includes a transmission adapter configured to communicatively couple with the customer processor, the delivery service processor, and the merchant processor for sending and receiving data.

In one aspect, the virtual assistant device is a software component deployed on or within the mobile device of the courier.

In one aspect, the virtual assistant device is further configured to process and announce navigational direction relating to the merchant location and the customer location.

In one aspect, the virtual assistant device is further configured autonomously, or upon verbal command from the courier, communicate with the delivery service processor, the merchant processor, or the customer processor to provide or request additional data or information.

In one aspect, the communication by the virtual assistant device can be an electric communication sent and received by the mobile device of the courier.

In one aspect, the virtual assistant device is configured to receive, process, and produce data during a food delivery pickup, delivery, and fulfilment stages of a food delivery process.

In one aspect, the virtual assistant device is configured to audibly broadcast recommendations and information to the courier in order to prevent the courier from engaging with the mobile device of the courier.

In one aspect, the recommendations being audibly broadcast by the virtual assistant device to the courier include recommendations regarding accepting or declining the food order.

In one aspect, the recommendations regarding accepting or declining the food order are based on a profitability of delivery of the food order.

In one aspect, the profitability of delivery of the food order is based on at least one of fuel efficiency of a delivery vehicle, total drive distance to complete the food order, traffic conditions, and total food order price.

According to another aspect, the present disclosure is directed to a method for processing orders for food through a network processor and transmitting the orders for food to a courier. The method can include one or more of the following method steps: transmitting, by a customer processor at a customer location, a food order through the network processor;
receiving, by a delivery service processor at a delivery service location, the food order through the network processor; transmitting, by the delivery service processor, through the network processor the food order to a merchant processor at a merchant location; receiving and processing, by the merchant processor, the food order from the delivery service processor through the network processor; transmitting, by the merchant processor, through the network processor a signal to the delivery service processor accepting the food order; and transmitting, by the delivery service processor, through the network processor the food order to a virtual assistant device at a courier location; receiving and processing, by the virtual assistant device, the food order from the delivery service processor; and audibly broadcasting, by the virtual assistant device, the data associated with the food order and recommendations based on the data associated with the food order to the courier.

In one aspect, the recommendations being audibly broadcast by the virtual assistant device to the courier include recommendations regarding accepting or declining the food order.

### BRIEF DESCRIPTION OF THE DRAWINGS

The foregoing Summary as well as the following Detailed Description will be best understood when read in conjunction with the appended drawings, which illustrate a preferred embodiment of the disclosure. In the drawings:

FIG. 1 is a schematic diagram of an exemplary system of the present disclosure.

FIG. 2 is a schematic diagram of components of the system of FIG. 1.

FIG. 3 is a schematic diagram of a basic diagram of a network of the present disclosure.

FIG. 4 is a schematic diagram of an intelligent virtual assistant platform of the present disclosure.

FIG. 5 is a schematic diagram of a mobile food delivery service utilizing the virtual assistant platform of FIG. 4.

FIGS. 6A and 6B are flowcharts illustrating a method of operating the system of the present disclosure.

### DETAILED DESCRIPTION OF THE PREFERRED EMBODIMENTS

The current technology of dynamic food order acceptance and fulfillment systems that use mobile couriers creates situations where the attention of the courier is divided between driving duties, administration of the business of fulfillment, and changing navigation tasks. Some of the work of the courier can be performed by a specialized virtual assistant component capable of understanding orders, verbally announcing details of orders, recommending courses of action, communicating with the delivery service, the merchant, or the customer by phone or text, detecting and analyzing verbal utterances or spoken words of the courier, and performing actions based on verbal courier input.

The fact that food order acceptance and fulfillment services of the present art do not include virtual assistant components unnecessarily creates risk for the courier and others on the road, and unnecessarily limits the efficiency of the courier. Consequently, it is desirable to provide a system comprising a virtual assistant designed to perform one or more of the following tasks: verbal communication with the courier, to understand details related to orders received for the courier, to perform tasks relevant to order fulfillment, such as assisting in navigation, communicating with customers, and recommending options to the courier, among other tasks not specifically listed. The present disclosure provides a system that can perform the aforementioned tasks to aid food delivery drivers or couriers in efficiently and safely performing their delivery tasks.

Currently, there exists computer-based intelligent virtual assistants that perform, in conjunction with mobile electronic devices, specific tasks on behalf of a user which user communicates with the virtual assistant through verbal two-way communication. Such verbal intelligent personal assistants interpret human speech and include artificial intelligence (AI) to analyze the intent of the user, decide a course of action, and autonomously perform actions on behalf of the user. The virtual assistant may be a stand-alone device such as, for example, Apple's Siri or Amazon's Alexa that includes communication means for verbally communicating with users, or it can be a software component designed to operate on a mobile or native computer device.

As outlined in Wikipedia, the virtual assistant offers to the user digital experiences that will achieve a status-weight comparable to “real” experiences. The user communicates with the virtual assistant as the user would communicate with a real person. Such a digital assistant can perform tasks much like a co-pilot would in a cockpit of an aircraft. Delivery drivers or couriers would greatly benefit from having a specialized intelligent virtual assistant that performs tasks for the drivers or couriers, aiding in safety and efficiency for the delivery drivers or couriers. Such a system is disclosed in the following disclosure.

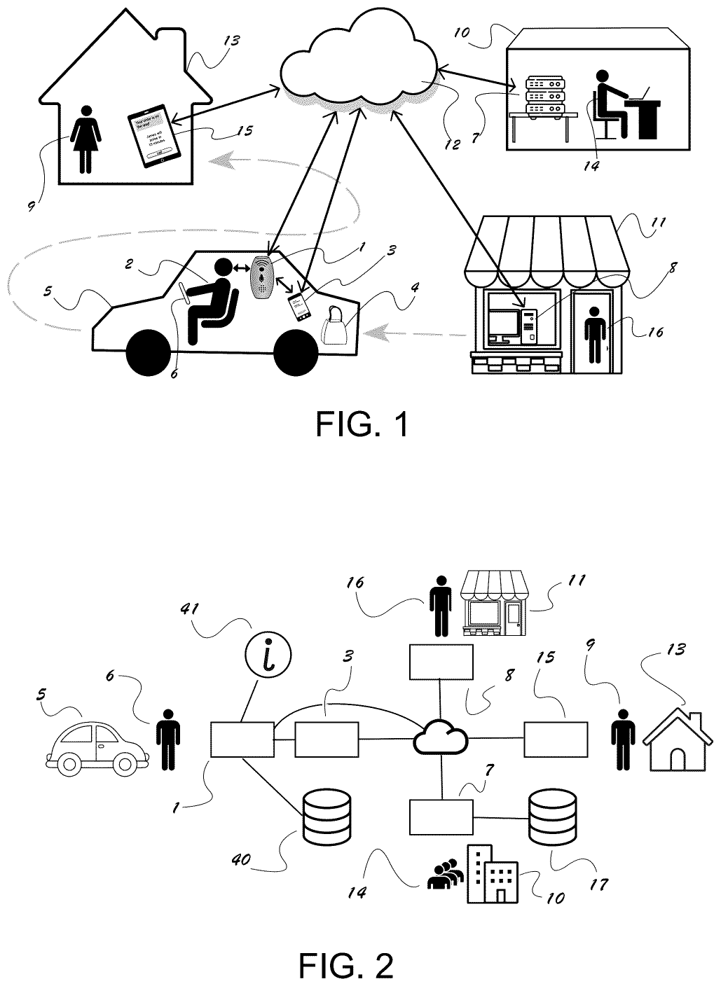

FIG. 1 is a schematic diagram of an exemplary system of the present disclosure. As illustrated in FIG. 1, a customer 9 in a first location 13 can place an order for food delivery on a connected device 15. The order is sent through a network 12 to a service provider network server 7 in a second location 10. The service provider network server 7 contains software that causes details regarding the customer's order to be transmitted to a connected device 8 of a merchant 16 in a third location 11. If the merchant 16 accepts the food order, then the connected device 8 of the merchant 16 sends a message accepting the order to the service provider network server 7, and the merchant commences preparation of the food 4 for delivery.

The service provider network server 7 then sends a message to a virtual assistant device 1 in a fourth location 5, which can be a vehicle 5 operated by a courier 2. When driving the vehicle 5, the courier 2 is instructed and expected to maintain eye contact with the road and hand contact with the steering wheel 6 of the vehicle 5 at all times, except to view an electronic GPS map in the vehicle 5. The service provider network server 7 sends the order related data to the courier mobile device 3 in the vehicle 5, and the courier mobile device 3 can be connected through Bluetooth or other wireless technology to the virtual assistant device 1. The virtual assistant device 1 can be configured to communicate through the courier mobile device 3 with the service provider support 14, the merchant 16, and the customer 9, all while the courier 2 concentrates on the task of driving the vehicle 5.

FIG. 2 is a schematic diagram of components of the system of FIG. 1. As illustrated in FIG. 2, the system includes the customer mobile device 15 whereby the customer 9 in the customer location 13 places the order through the customer mobile device 15. The order is sent through the network 12 by sending data related to the order to the service provider network server 7 in the location 10, and a processor of the service provider network server 7 accesses the data to process the order. The service provider network server 7 sends data related to the order to the merchant processor 8 in the location 11, and the merchant 16 accepts or declines the order. If the merchant 16 declines the order, then the merchant processor 8 notifies the service provider network server 7 though the network 12 that the order is declined, and the service provider network server 7 notifies the customer 9 through the network 12 and the customer connected device 15 that the order has been declined. If the merchant 16 accepts the order, then the merchant processor 8 notifies the service provider network server 7 though the network 12 that the order is confirmed, and the service provider network server 7 notifies the customer 9 through the network 12 and the customer connected device 15 that the order is confirmed.

In addition, the service provider network server 7 sends data related to the order to the virtual assistant device 1 in the vehicle 5 through the network 12 and the courier mobile device 3. After the virtual assistant device 1 receives the order related data from the service provider network server 7, the virtual assistant device 1 processes the data along with other data received from the database component 40 and the knowledge base component 41 to produce announcements related to the order. Further, the virtual assistant device 1 can be configured to process requests and comments uttered or spoken by the courier 2 to accept or decline the order, further analyze and announce additional facts related to the order, and/or produce tasks related to communications with the service provider support staff 14, the merchant 16, and/or the customer 9. The aforementioned communications can be performed by the virtual assistant device 1 through text messages and/or phone calls, using a Bluetooth or other wireless technology with the courier mobile device 3 and through the network 12 to the service provider network server 7, the merchant processor 8, and/or the customer connected device 15, respectively.

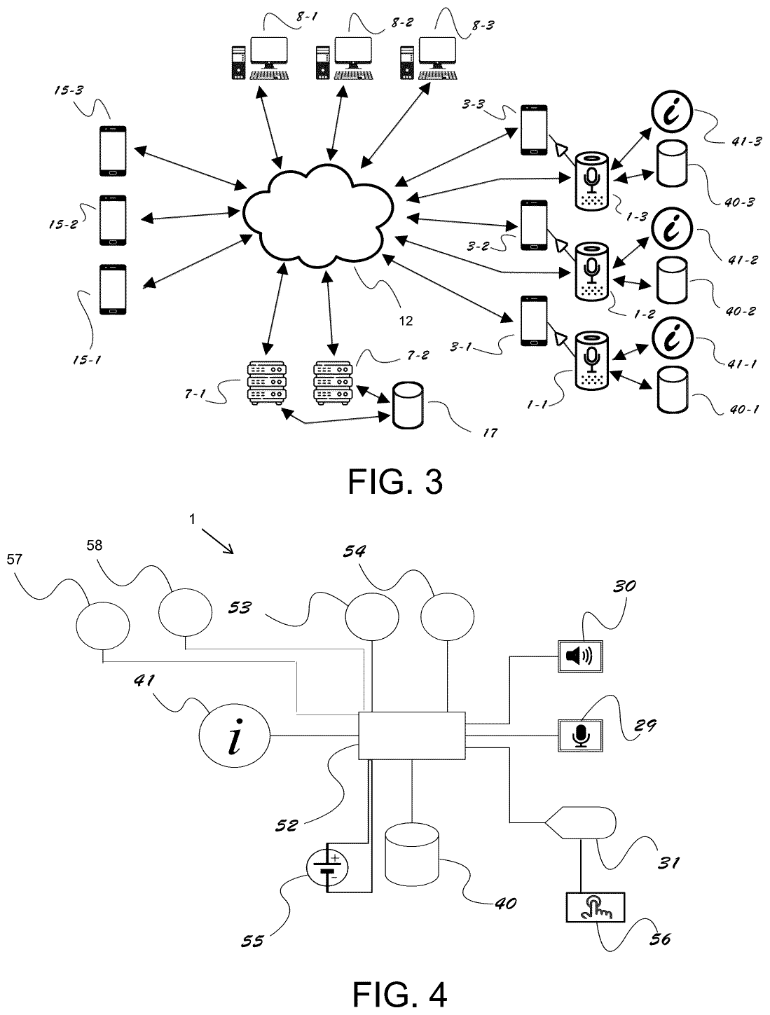

FIG. 3 is a schematic diagram illustrating an architecture of a network of the system of the present disclosure. As illustrated in FIG. 3, the system includes the central network 12 server processor which serves to execute programs that process and transmit data passing from connected processors and devices to other processors and connected devices. One or more customer devices 15-1, 15-2, 15-3 receive data through a website on the network 12 server processor and transmit the data through the central network 12 server processor to one or more service provider network servers 7-1, 7-2. The service provider network server 7-1, 7-2 process the data and use data stores in storage device 17 to choose one or more merchant processors 8-1, 8-2, 8-3, which merchant processors 8-1, 8-2, 8-3 notify associated merchants that there is an order.

If the associated merchant accepts the order, then the merchant processor 8-1, 8-2, 8-3 transmits a message through the network 12 server processor to the service provider network server 7-1, 7-2 accepting the order. If the order is accepted, then the service provider network server 7-1, 7-2 transmits a notification of order and data related to the order through the network 12 server to one or more virtual assistant devices 1-1, 1-2, 1-3 and to the courier mobile device 3-1, 3-2, 3-3 of the associated courier 2. In addition, the service provider network server 7-1, 7-2 may also send data related to the order to the courier mobile device 3-1, 3-2, 3-3 for backup or archiving. The virtual assistant device 1-1, 1-2, 1-3 subsequently analyzes the data, knowledge data in the knowledge base 41-1, 41-2, 41-3, and data stored in the database 40-1, 40-2, 40-3 based on certain criteria previously entered by the courier 2. The virtual assistant device 1-1, 1-2, 1-3 then formulates a recommendation for accepting or rejecting the order.

The virtual assistant device 1-1, 1-2, 1-3 can be configured to verbally announce the order opportunity and its recommendation. If the courier 2 desires more information about the order, then the courier 2 verbally requests this additional information and the virtual assistant device 1-1, 1-2, 1-3 verbally provides additional information. After the courier 2 concurs or defers with the virtual assistant device's 1-1, 1-2, 1-3 decision, then the final decision of the courier 2 is transmitted. If the order is accepted by the courier 2, then the virtual assistant device 1-1, 1-2, 1-3 commences navigation to the merchant location 11, which navigation may include activating a GPS device in the vehicle 5 with the merchant's location 11 as a target point. After the order is picked up by the courier 2, the courier 2 tells the virtual assistant device 1-1, 1-2, 1-3 that the order has been picked up and virtual assistant device 1-1, 1-2, 1-3 commences navigation to the customer 9.

While the courier 2 is navigating to the merchant 16 or the customer location 13, the virtual assistant device 1-1, 1-2, 1-3 engages and accesses data and knowledge resources to determine the status of the order. The virtual assistant device 1-1, 1-2, 1-3 has the capability to determine abnormalities and communicates abnormalities verbally with the courier 2. For example, the virtual assistant device 1-1, 1-2, 1-3 may utter or vocalize, “I detect a slowdown on your intended route. Do you want me to text the customer that there is a delay?” Upon specific verbal command from the courier 2, the virtual assistant device 1-1, 1-2, 1-3 may formulate or transcribe messages to the merchant 16, the delivery service provider support 14, or the customer 9. The virtual assistant device 1-1, 1-2, 1-3 can also read messages from the merchant 16, the delivery service provider support 14, or the customer 9, analyze the messages, and announce the messages to the courier 2 with suggested responses. The virtual assistant device 1-1, 1-2, 1-3 may also initiate phone calls through the courier mobile device 3-1, 3-2, 3-3, which phone calls the virtual assistant device 1-1, 1-2, 1-3 operates in an automated fashion or which are passed to the courier 2 via a speaker system of the courier mobile device 3-1, 3-2, 3-3.

There may be an embodiment of the present disclosure in which a system having the virtual assistant device 1 is implemented as a software component on a device that also is a mobile device 3, such as a cell phone device. For safety purposes, the system of the preferred embodiment of the present disclosure includes a physical device, separate from a handheld courier mobile device 3 (i.e., a cell phone), that serves as the virtual assistant. This is intended to reduce the chance that the courier 2 engages with the courier mobile device 3 while driving the vehicle 5. With that said, the present disclosure includes embodiments in which the virtual assistant device 1 is separate from the courier mobile device 3 (cell phone), and an embodiment in which the virtual assistant device 1 is integrated in the courier mobile device 3 (cell phone). In the latter embodiment, a feature could be included in the courier mobile device 3 to prevent the courier 2 from physically interacting with the courier mobile device 3 during active driving of the vehicle 5.

FIG. 4 is a schematic diagram of an intelligent virtual assistant device 1 platform of the present disclosure. As illustrated in FIG. 4, the virtual assistant device 1 of the present disclosure includes a processor 52 configured to execute software applications and perform data and neuromorphic processing tasks. The data required for executing tasks is stored in a data storage 40, and knowledge information is stored in a knowledge data device 41. The virtual assistant device 1 of the present disclosure further includes a power source 55, a Bluetooth or other wireless adapter 53 for connecting to the courier mobile device 3, and a transmission adapter 54 for connecting networks. The virtual assistant device 1 also includes interaction components, such as a speaker 30 for audibly broadcasting data and information, a microphone 29 for verbally communicating with the courier 2, and a display 31 for displaying graphics such as animations, photos, or text. The display 31 can include a touch screen component 56 for entering data when appropriate, but which touch screen component 56 can be disabled when the virtual assistant device 1 is operational in a delivery or waiting for a delivery. To enforce compliance with the requirement that the user/courier/driver refrain from visually or manually engaging the virtual assistant device 1, the system detects movement of the vehicle 5 and/or virtual assistant device 1 through a GPS sensor 57, a movement sensor 58, or a combination of the sensors, and the system disables any display of information or touch input other than navigational information when movement is detected.

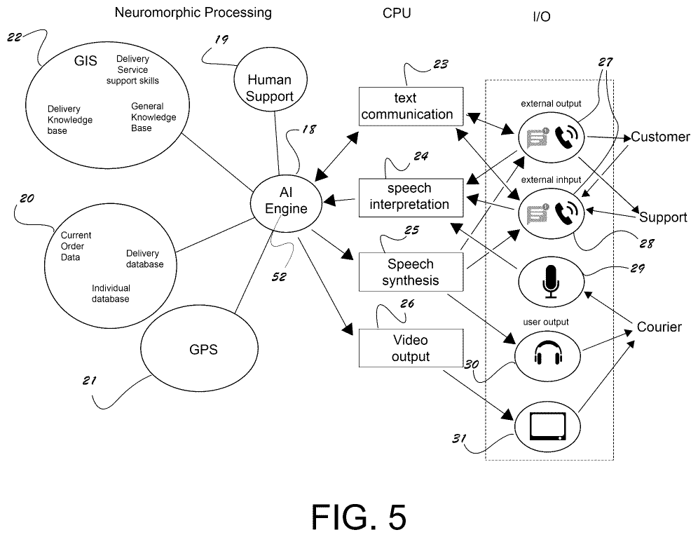

FIG. 5 is a schematic diagram of a mobile food delivery service utilizing the virtual assistant device 1 of FIG. 4. As illustrated in FIG. 5, the virtual assistant device 1 of the present disclosure can utilize a processor 18 to execute a software AI (artificial intelligence) engine 52 to perform the tasks that would be performed by a human being in assisting the courier 2 to perform the tasks required to process an order (other than driving the vehicle 5). The platform simulates in neuromorphic processing the cognitive function that human minds perform, such as receiving and analyzing a food delivery order, problem-solving, learning, reasoning, food order delivery intelligence, navigation intelligence, social intelligence, and general knowledge.

As schematically illustrated, the artificial intelligence (AI) code executed in the processor 18 of the AI engine 52 is configured to access a data base 20 to retrieve data related to the current order, data related to the delivery system of service provider, and data related to the courier 2. Further, the processor 18 of the AI engine 52 is configured to access a knowledge base 22 for AI intelligence information related to delivery systems, geography of the area, delivery service customer support skills, and general knowledge. The AI engine 52 has dynamic access to GPS data 21, access to live human support 19 (which may be access to the courier 2), access to the delivery service support staff 14, access to the merchant 16, and/or access to the customer 9.

Further, the AI engine 52 uses communication component text communication 23 to formulate and read text messages that are sent and received. The AI engine 52 uses a speech interpretation component 24 to convert spoken input into text data for use in the AI engine 52. In addition, the AI engine 52 converts text data to spoken word for communication with humans in speech synthesis module 25, and the AI engine 52 displays images on an associated display through video output module 26. In the input/output system, which is communicatively coupled to the AI engine 52, the system of the virtual assistant device 1 includes a communication component 27 for communicating with customers 9 and with support, including the delivery service support 14 and the merchant 16. The input/output system of the virtual assistant device 1 furthermore includes, as discussed, microphone means 29 for receiving verbal input from the courier 2, speaker means 30 for creating sound output (audibly broadcasting information) for the courier 2, and display means 31 for displaying status data to the courier 2.

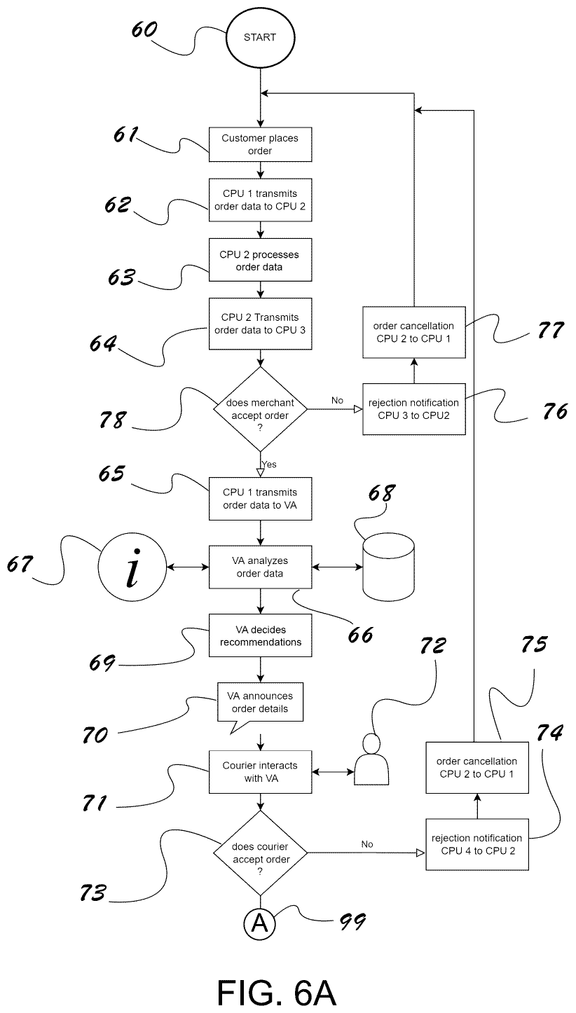

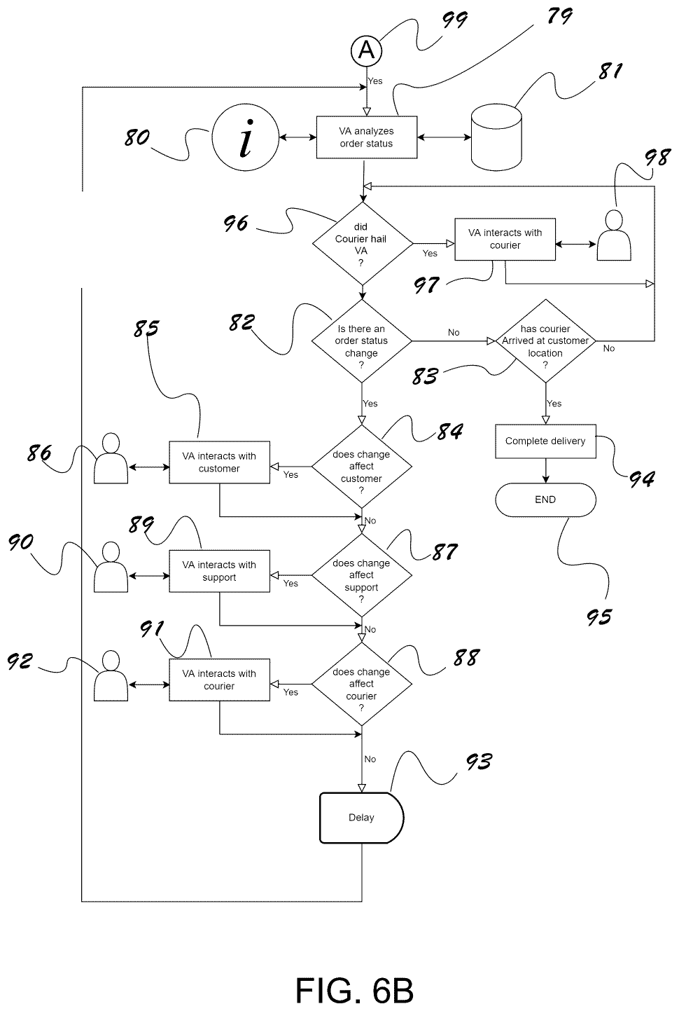

FIGS. 6A and 6B are flowcharts illustrating a method of operating the system of the present disclosure. As illustrated in FIGS. 6A and 6B, a flowchart for the system of the present disclosure commences or starts at step 60 and then a customer places an order at step 61. At step 62, the customer's device, CPU-1, transmits data to the delivery service provider's server, CPU-2. The delivery service provider's server, CPU-2, processes the order data at step 63. Then at step 64, data is transmitted to the merchant processor CPU-3. If the merchant decides in step 78 not to accept the order, then the merchant processor CPU-3 transmits a rejection notification message to the delivery service provider processor CPU-2 in step 76. Further, the service provider processor, CPU-2, transmits the order cancellation message to the customer processor, CPU-1, in step 77.

If the merchant decides in step 78 to accept the order, then the delivery service provider processor, CPU-2, transmits an announcement of the order and order data to the virtual assistant, VA, in step 65. The virtual assistant then accesses knowledge about the order processing and other relevant information in the knowledge base 67, and data related to order processing in database in 68 for analyzing the data in step 66. The virtual assistant's artificial intelligence produces a recommendation at step 69, which is announced verbally to the courier in step 70. The courier may interact verbally with the virtual assistant to learn more about the order at step 71, to aid in making a final decision related to acceptance or rejection of the order.

If the courier does not accept the order, then in step 74 the virtual assistant operates the courier's mobile device, CPU-4, through Bluetooth (or other wireless technology) to transmit the rejection notification to the delivery service provider processor, CPU-2. Then in step 75, the service provider processor, CPU-2 transmits the order cancellation notice to the customer processor, CPU-1. If the courier decides in step 73 to accept the order, then in step 79 the system enters a loop in which the virtual assistant continuously monitors the courier input and order status data using data in the database 81 and knowledge in the knowledge base 80. In step 96, if the courier has hailed the virtual assistant, then in step 97 the virtual assistant responds and interacts with courier 98 before entering the loop again.

If the courier has not hailed the virtual assistant in step 96, then in step 82 the system decides if there is an event that signifies a change in the order status. If such a change in order delivery status has been detected, then the virtual assistant decides if the change affects customer in step 84. If the change affects the customer, then the virtual assistant interacts with the customer 86 in step 85. For example, the virtual assistant may connect to the courier's mobile device via Bluetooth (or other wireless connection) and send a text to the customer 86, advising the customer 86 of the change in order delivery status.

Next, in step 87, the virtual assistant decides if the change affects delivery service support staff. If the change affects the delivery service support staff, then the virtual assistant interacts with the delivery service support staff 90 in step 89. For example, the virtual assistant may connect to the courier's mobile device via Bluetooth (or other wired or wireless connection) and send a text to the delivery service support staff 90, advising the delivery service support staff 90 of the change in order delivery status and asking for advice. The virtual assistant proceeds by deciding if the change affects the courier in step 88. If the change affects the courier, then the virtual assistant interacts with the courier 92 in step 91. For example, the virtual assistant may announce to the courier 92, advising the courier 92 of the change in order delivery status and asking for instructions.

As illustrated, in step 93, the virtual assistant interaction loop in the system may pause at any logistically appropriate time before continuing and repeating interaction steps. If, in step 82, the system found that there was no change in the order delivery status, then the system checks if the courier has arrived at the customer's location. If the system has arrived at the customer's location, then the virtual assistant system performs order completion tasks, which order completion tasks may include verification that the order has been delivered. The system and method then end at step 95 upon delivery and verification of the delivery.

The present disclosure describes a system in which a courier on the road and engaged with a delivery service interfaces with a virtual assistant device 1, not by manipulating and viewing a mobile device, but instead by verbally communicating with an intelligent virtual assistant device 1. The intelligent virtual assistant device 1 can be configured to perform the tasks that usually require manipulation and visual inspection of a mobile device, so that the courier can keep their eyes on the road and hands on the steering wheel at all times during the delivery process. As will be appreciated by those having ordinary skill in the art, the virtual assistant device 1 of the present invention may function as a communication device with a network so that it can function as a phone. Alternatively, the virtual assistant device 1 may be implemented as a software component running on a mobile device. Alternatively, the virtual assistant device 1 can be an entirely separate device from a mobile device. It is the intention of the Applicant of the present disclosure to include such implementations or embodiments of the present invention in the present application, even if not explicitly disclosed in detail.

Disclosed is a virtual assistant system. The virtual assistant system can be implemented as a computer program product that is necessarily rooted in at least one processor to improve operations of the at least one processor and any computing system or environment including the at least one processor. The operations of the at least one processor, as directed by the virtual assistant system implemented as the computer program product, can be considered a data preparation and/or multi-step data manipulation system, for example converting non-standardized data/information into standardized data/information.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

What is claimed is:

1. A system for processing orders for food through a network processor and transmitting the orders for food to a courier, the system comprising:
a customer processor at a customer location configured to transmit a food order through the network processor;
a delivery service processor at a delivery service location configured to receive the food order and transmit the food order to a merchant processor at a merchant location, wherein the merchant processor is configured to process the food order and transmit a signal to the delivery service processor accepting or declining the food order; and
a virtual assistant device at a courier location, the virtual assistant device being communicatively coupled to a mobile device of the courier, wherein the virtual assistant device is configured to receive food order data, process the food order data, and produce recommendations based on the food order data, with the recommendations being at least audibly broadcast to the courier.

2. The system of claim 1, wherein the virtual assistant device includes a speaker for audibly broadcasting information to the courier.

3. The system of claim 2, wherein the audible broadcasting of information comprises verbally broadcasting information to the courier while the courier drives a vehicle.

4. The system of claim 1, wherein the virtual assistant device includes a microphone for receiving verbal inputs from the courier while the courier drives a vehicle.

5. The system of claim 1, wherein the virtual assistant device is a separate physical device from the mobile device of the courier, and the virtual assistant device is positioned within proximity of the mobile device of the courier.

6. The system of claim 5, wherein the virtual assistant device comprises:
a microphone configured to receive verbal inputs from the courier;
a speaker configured to audibly broadcast information to the courier;
a display configured to display graphics, wherein the display includes a touch screen component configured for entering data and controlling the virtual assistant device; and
a power source for providing electrical energy to the virtual assistant device.

7. The system of claim 6, wherein the touch screen of the display is at least partially disabled when the courier and the virtual assistant device are in motion.

8. The system of claim 1, wherein the virtual assistant device comprises a wireless adapter for communicatively coupling the virtual assistant device to the mobile device of the courier through wireless technology.

9. The system of claim 1, wherein the virtual assistant device comprises a transmission adapter configured to communicatively couple with the customer processor, the delivery service processor, and the merchant processor for sending and receiving data.

10. The system of claim 1, wherein the virtual assistant device is a software component deployed on or within the mobile device of the courier.

11. The system of claim 1, wherein the virtual assistant device is further configured to process and announce navigational direction relating to the merchant location and the customer location.

12. The system of claim 1, wherein the virtual assistant device is further configured autonomously, or upon verbal command from the courier, communicate with the delivery service processor, the merchant processor, or the customer processor to provide or request additional data or information.

13. The system of claim 12, wherein the communication by the virtual assistant device can be an electric communication sent and received by the mobile device of the courier.

14. The system of claim 1, wherein the virtual assistant device is configured to receive, process, and produce data during a food delivery pickup, delivery, and fulfilment stages of a food delivery process.

15. The system of claim 1, wherein the virtual assistant device is configured to audibly broadcast recommendations and information to the courier in order to prevent the courier from engaging with the mobile device of the courier.

16. The system of claim 1, wherein the recommendations being audibly broadcast by the virtual assistant device to the courier include recommendations regarding accepting or declining the food order.

17. The system of claim 16, wherein the recommendations regarding accepting or declining the food order are based on a profitability of delivery of the food order.

18. The system of claim 17, wherein the profitability of delivery of the food order is based on at least one of fuel efficiency of a delivery vehicle, total drive distance to complete the food order, traffic conditions, and total food order price.

19. A method for processing orders for food through a network processor and transmitting the orders for food to a courier, the method comprising:
transmitting, by a customer processor at a customer location, a food order through the network processor;
receiving, by a delivery service processor at a delivery service location, the food order through the network processor;
transmitting, by the delivery service processor, through the network processor the food order to a merchant processor at a merchant location;
receiving and processing, by the merchant processor, the food order from the delivery service processor through the network processor;
transmitting, by the merchant processor, through the network processor a signal to the delivery service processor accepting the food order; and
transmitting, by the delivery service processor, through the network processor the food order to a virtual assistant device at a courier location;
receiving and processing, by the virtual assistant device, the food order from the delivery service processor; and
audibly broadcasting, by the virtual assistant device, the data associated with the food order and recommendations based on the data associated with the food order to the courier.

20. The method of claim 19, wherein the recommendations being audibly broadcast by the virtual assistant device to the courier include recommendations regarding accepting or declining the food order.
